(19) United States
(12) Patent Application Publication
(10) Pub. No.: US 2023/0225291 A1
(43) Pub. Date: Jul. 20, 2023

(54) PET HARNESS WITH INTEGRATED LEASH

(71) Applicant: TUG PET PRODUCTS, LLC., Raleigh, NC (US)

(72) Inventors: Timothy NEAL, Toa Baja, PR (US); Zhichao YE, Shanghai (CN)

(73) Assignee: TUG PET PRODUCTS, LLC., Raleigh, NC (US)

(21) Appl. No.: 18/155,237

(22) Filed: Jan. 17, 2023

(30) Foreign Application Priority Data
Jan. 17, 2022 (CN) 202220112471.1

(51) Int. Cl. A01K 27/00

(52) U.S. Cl. CPC A01K 27/002; A01K 27/004

(57) ABSTRACT

An integrated pet harness with a pet leash, including: a flexible back pad and a flexible chest pad, a pair of first connecting straps and a second connecting strap, oppositely arranged;: connecting to the flexible back pad and the telescopic traction rope on the pad, and the telescopic traction rope can be accommodated in the flexible back pad. The front end of the flexible back pad is provided with a pair of first extension parts extending to both sides; the rear end of the flexible back pad is provided with a pair of second extension parts extending to both sides. There are a pair of third extension parts extending to both sides respectively; a pair of first connecting strips are fixed to the front end of the flexible back pad, and two ends of the pair of first connecting strips are respectively passed through the pair of first extending parts.

### FIELD

The embodiments relate to the field of pet appliances, to a pet harness and a pet rope integrated with pet ropes, which are suitable for dog traction.

### BACKGROUND

Pet ownership is increasing each year, especially pet dogs. Walking your dog outside most certainly requires a leash and is even mandated by many local governments. In certain environments, such as an enclosed dog park or neighborhood, a dog’s leash will be temporarily removed.

With the threat of automobile traffic or an encounter with another animal, a pet owner needs the ability to control their dog quickly for everyone’s safety. Most dog owners accomplish this by grasping the dog’s collar by hand; however, it is only a temporary solution until a leash can be connected.

Therefore, this invention of a more convenient and practical integrated leash is the answer to this technical problem. The invention allows a dog owner to use the integrated leash with the collar and prevents users from hunching over while controlling their dog.

### SUMMARY

The embodiments aim to solve the above-mentioned technical problems in the prior art that the pet harness cannot be adapted to pets of different types and sizes through a simple size adjustment structure, and the matching pet leash cannot be conveniently stored on the pet harness at any time without affecting the pet’s activities.

To solve the above technical problems, the technical scheme adopted by the embodiments is: An exemplary embodiment of an integrated pet harness with a pet leash, comprising: a flexible back pad and a flexible chest pad, a pair of first connecting straps and a second connecting strap, which are oppositely arranged, and further comprising:
The telescopic traction rope is connected to the flexible back pad, and the telescopic traction rope can be accommodated in the flexible back pad.
The front end of the flexible back gasket is provided with a pair of first extension portions extending to both sides respectively, and the rear end of the flexible back gasket is provided with a pair of second extension portions extending to both sides respectively;
The front end of the flexible chest pad is provided with a pair of third extensions extending to both sides respectively;
A pair of first connecting straps are respectively fixed to the front ends of the flexible back pads, and two ends of the pair of first connecting straps are respectively protruded from the pair of first extending portions and are respectively connected to the pair of third extending portions;
The second connecting strip passes through the rear end of the flexible back pad, and two ends of the second connecting strip are respectively connected to a pair of second extending portions correspondingly.

Further, the telescopic traction rope includes:

The elastically retractable traction section and the hand-held section, one end of the traction section is fixedly connected to the rear end of the flexible back gasket, one end of the hand-held section is connected to the other end of the traction section, and the other end of the hand-held section is fixedly connected to the middle of the hand-held section and forms Flexible handle for holding; The flexible back pad is provided with at least one first magnetic attraction structure, and one side of the traction section is provided with a second magnetic attraction structure matched with the first magnetic attraction structure.

Preferably, at least one-third magnetic attraction structure is provided on the hand-held segment, and a fourth magnetic attraction structure matched with the third magnetic attraction structure is provided on the other side of the traction segment.

Preferably, the traction section is made of a retractable belt rope, and the inside of the flexible handle is provided with a non-slip lining,

Further, it also includes:

The first interlayer is arranged at the top front end of the flexible back gasket. The first interlayer is respectively provided with a pair of first openings corresponding to a pair of first extension parts, and two ends of a pair of first connecting strips are respectively corresponding to a pair of first openings. Passing out, the first connecting strip is fixed in the first interlayer, and the other end of the first connecting strip is fixedly connected to the flexible back gasket at the place where the first connecting strip passes through the first opening.

Further, it also includes:
a first fastener, comprising a hollow first fastener frame, a first crossbar arranged on the first fastener frame, and the first crossbar divides the hollow part of the first fastener frame into a pair of first through-holes;
One end of the first connecting belt is inserted between a pair of first through-holes from one side of the first crossbar, the first fastener is passed through the first connecting belt, and the first connecting belt is on the flexible back pad. A first movable segment with a movable adjustable length is formed between the sheet and the first fastener;
After one end of the first connecting belt is passed out of the first fastener, it is again inserted between a pair of first through-holes from one side of the first crossbar, and is fixedly connected after being passed out of the first fastener again. A first collar is formed on the first connecting belt and one end of the first connecting belt is sleeved on the first crossbar, and finally, the first connecting belt is fixedly connected to the third extension part, and the first connecting belt is on the third extension part. The length between the first fastener and the connection between the first connection band and the third extension part can be adjusted movably corresponding to the length of the first movable segment.

Further, it also includes:

The second interlayer is arranged at the bottom rear end of the flexible chest pad, the second interlayer is respectively provided with a pair of second openings on both sides of the bottom rear end of the pair of flexible chest pads, and the two ends of the second connecting belt are respectively opened from a pair of second openings. The second openings are correspondingly passed out, and the second connecting belt is fixedly connected to the flexible chest pad at the place passing through the second openings.

Further, it also includes:
The second fastener includes a hollow second fastener frame, and a second crossbar disposed on the second fastener frame, and the second crossbar divides the hollow portion of the second fastener frame into a pair of second through holes;
The third fastener includes a hollow third fastener frame, and a third crossbar arranged on the third fastener frame. The third crossbar divides the hollow part of the third fastener frame into a pair of third through-holes, which are provided with The buckle structure on the third buckle frame; One end of the second connecting strip is inserted from one side of the second crossbar between a pair of second through-holes, and the second fastener is passed through the second connecting strip, and the second connecting strip is on the second buckle. A second movable segment with adjustable length is formed between the piece and the flexible chest pad;
After one end of the second connecting belt is passed through the second fastener, one end of the second connecting belt is inserted between a pair of third through-holes from one side of the third crossbar, and the third fastener is passed through the pair of third through holes. set on the second connecting belt;
After one end of the second connecting belt is passed out of the third fastener, it is inserted between a pair of second through-holes from one side of the second transverse rod and finally passes out of the second fastener.

Further, it also includes:

The third connecting strip is arranged on the third interlayer at the top and rear end of the flexible back gasket. The third interlayer is respectively provided with a pair of third openings corresponding to the pair of second extension parts. The three openings are correspondingly passed out, and the third connecting strip is fixedly connected to the flexible back gasket at the place passing through the third opening;

A card slot structure matched with the buckle structure, the card slot structure includes: a card slot insertion frame, one end of the card slot insertion frame is provided with a fourth crossbar, and a fourth crossbar is formed between the fourth crossbar and the card slot insertion frame. Four through-holes; one end of the third connecting strip passes through a pair of fourth through-holes from one side of the fourth crossbar, and the card slot inserting frame is passed through the third connecting strip; the third connecting strip One end of the third connecting band is fixedly connected to the third connecting band after passing out of the card slot inserting frame, and forms a second collar for sleeves one end of the third connecting band on the fourth crossbar.

Preferably, the third extension portion is provided with a limit ring through which the first movable segment passes.

Compared with the prior art, the pet harness provided by embodiments may be adapted to pets of different types and sizes through a simple size adjustment structure, and the matching pet rope can be conveniently stored on the harness at any time without affecting pet activities.

### BRIEF DESCRIPTION OF THE DRAWINGS

To illustrate the technical solutions in the embodiments more clearly, the following briefly introduces the accompanying drawings that need to be used in the description of the embodiments or the prior art. The drawings in the following description are only for the present utility model. For some novel embodiments, for those of ordinary skill in the art, other drawings can also be obtained according to these drawings without any creative effort.

FIG. 1 is a schematic diagram of the assembly structure of an integrated pet harness with a pet leash in an embodiment.

### DETAILED DESCRIPTION

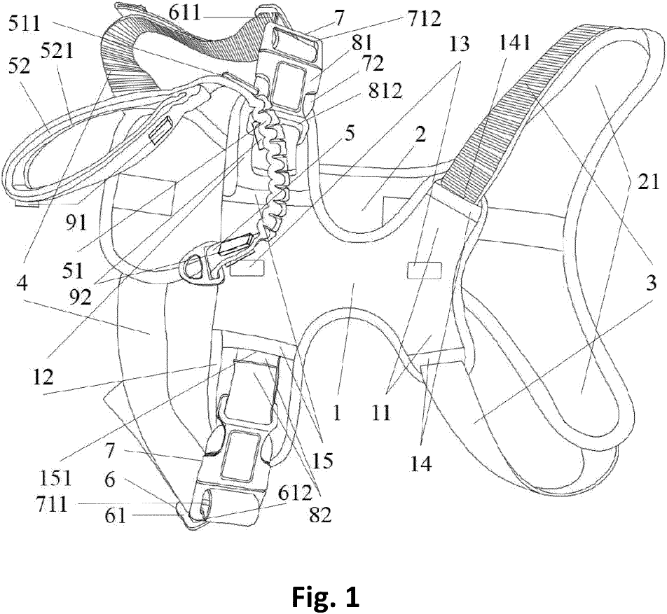

The embodiments will be further described in detail below in conjunction with the accompanying drawings 1 and the embodiments. It should be understood that the specific embodiments described herein are only used to explain the embodiments, and are not intended to limit the embodiments. The principle and structure of the embodiments will be described in detail below in reference to FIG. 1 and the embodiments.

Please refer to FIG. 1, the pet leash integrated pet harness provided by the embodiments includes: a flexible back pad 1 and a flexible chest pad 2 arranged oppositely, a pair of first connecting straps 3 and second connecting straps 4, and includes: a telescopic traction rope 5 connected to the flexible back pad 1, and the telescopic traction rope 5 can be received and fixed on the flexible back pad 1 .

In this embodiment, the front end of the flexible back gasket 1 is provided with a pair of first extending portions 11 extending to both sides respectively, and the rear end of the flexible back gasket 1 is provided with a pair of second extending portions extending to both sides respectively 12; As a preferred embodiment, the length of the second extension portion 12 is greater than that of the first extension portion 11 so that the flexible back pad 1 has an H-shaped structure with a long left side and a short right side when the flexible back pad 1 is unfolded in its plane. In this embodiment, the front end of the flexible chest pad 2 is provided with a pair of third extending portions 21 extending to both sides respectively; as a preferred embodiment, the rear end of the flexible chest pad 2 is provided with a pair of third extending portions 21 extending to both sides respectively A pair of protrusions, a pair of third extension parts 21 extend obliquely outward in the direction away from the rear end and side end of the flexible chest pad 2 at the same time, so that the flexible chest pad 2 is in the shape of a Y-shaped sheet in its flat unfolded state. structure. In this embodiment, a pair of first connecting strips 3 are respectively fixed to the front ends of the flexible back pads 1, and both ends of the pair of first connecting strips 3 are respectively protruded from a pair of first extending portions 11, and are respectively Connected to a pair of third extension parts 21; the second connection strip 4 passes through the rear end of the flexible back pad 1, and two ends of the second connection strip 4 are respectively connected to the pair of second extension parts 12. As a preferred embodiment, the flexible back pad 1 and the flexible chest pad 2 are arranged up and down relative to each other, and the overall length of the flexible chest pad 2 is greater than that of the flexible back pad 1, and its overall width is equal to the flexible back pad 1; the flexible back pad The sheet 1, the flexible chest pad 2, the first connecting strap 3 and the second connecting strap 4 constitute a pet harness, wherein the flexible back pad 1 is placed on the back of a pet such as a dog, and the flexible chest pad 2 is attached to the pet’s chest, the pair of first extension parts 11 at the front end of the flexible back pad 1 are respectively connected with the pair of third extension parts 21 at the front end of the flexible chest pad 2 through the first connection belt 3, and the flexible back pad 2 is connected by the second connection belt 4 A pair of second extension parts 12 at the rear end of the back pad 1 are respectively connected with both sides of the rear end of the flexible chest pad 2, and are connected between the flexible back pad 1, the pair of first extension parts 11, the first connecting belt 3, the Between the third extension part 21 and the flexible chest pad 2, a front opening for the pet’s head to pass through and sleeved on the chest under the pet’s neck is formed; in the first extension part 11, the flexible back pad 1. The second extension portion 12, the second connecting belt 4, the rear end of the flexible chest pad 2, the flexible chest pad 2, the third extending portion 21 and the first connecting belt 3 are surrounded by a front limb of the pet. The side opening (the side opening is provided with one on each side of the strap); between the flexible back pad 1, a pair of second extension parts 12, the second connecting strap 4, and the rear end of the flexible chest pad 2 The back half of the pet is stretched out and sleeved on the back opening of the front abdomen under the pet’s back and chest. By adjusting the first connecting belt 3 and the second connecting belt 4, the size of the front opening, the rear opening, or the side opening can be changed. Until the pet carrier is completely fitted under the pet’s neck, chest, front belly, and back, it can match various pets of different body types or different growth stages of the same breed.

In this embodiment, the telescopic traction rope 5 includes: an elastically retractable traction section 51 and a hand-held section 52. One end of the traction section 51 is fixedly connected to the rear end of the flexible back pad 1, and one end of the hand-held section 52 is connected to the traction section. The other end of 51, the other end of the hand-held section 52 is fixedly connected to the middle of the hand-held section 52 and forms a flexible handle for holding; at least one first magnetic attraction structure 13 is provided on the flexible back gasket 1, and a The side is provided with a second magnetic attraction structure 511 that cooperates with the first magnetic attraction structure 13, so that the traction section 51 can be adsorbed and fixed on the top of the flexible back pad 1. In one embodiment, the first magnetic attraction structure 13 and the second magnetic attraction structure 511 are a pair of mother and daughter magnets with opposite polarities and can attract each other; in another embodiment, the first magnetic attraction structure 13 and One of the second magnetic attraction structures 511 is a magnet, and the other one is made of a magnetic material (such as a ferromagnetic material) that can be attracted by the magnet; in other embodiments, the first magnetic attraction structure 13 and the second magnetic attraction structure 511 can be replaced by a mother-in-law Velcro.

As an alternative embodiment (not shown in the figure), at least a third magnetic attraction structure 91 is further provided on the hand-held segment 52, and the traction segment 51 is on the opposite side of the side where the second magnetic attraction structure 511 is provided. There is a fourth magnetic attraction structure 92 that cooperates with the third magnetic attraction structure 91, so that while the traction section 51 is adsorbed on the top of the flexible back pad 1, the hand-held section 52 can be further adsorbed to the traction section 51, so that the retractable traction rope is 5 Fully folded for storage in flexible back spacer 1. As a preferred embodiment, the traction section 51 is made of a retractable belt rope, and the inside of the flexible handle is provided with a non-slip or padded lining 521. In one embodiment, the third magnetic attraction structure 91 and the fourth magnetic attraction structure 92 are a pair of mother and daughter magnets with opposite polarities that can attract each other; in another embodiment, the third magnetic attraction structure 91 and One of the fourth magnetic attraction structures 92 is a magnet, and the other one is made of a magnetic material (such as a ferromagnetic material) that can be attracted by the magnet; in other embodiments, the third magnetic attraction structure 91 and the fourth magnetic attraction structure 92 can be replaced by mother and daughter Velcro.

This embodiment further includes: a first interlayer 14 (not shown in the figure) disposed at the top front end of the flexible back gasket 1, and a pair of first interlayers 14 are respectively opened on a pair of first extension parts 11 correspondingly. Openings 141, two ends of a pair of first connecting strips 3 respectively pass through a pair of first openings 141 correspondingly, and the first connecting strips are fixed in the first interlayer, and the other end of the first connecting strips 3 is in the first opening 141. A connecting belt 3 is fixedly connected to the flexible back gasket 1 through the first opening 141; the first fastener (not shown in the figure) includes a hollow first fastener frame, and a first crossbar, the first crossbar divides the hollow part of the first fastener frame into a pair of first through holes; one end of the first connecting strip 3 extends downward from the flexible back gasket 1 and extends from the first crossbar One side of the flexible backing pad 1 is inserted between a pair of first through holes, and the first fastener is inserted on the first connecting strip 3, which is formed between the flexible back gasket 1 and the first fastener. The first movable section with adjustable length; one end of the first connecting band 3 is passed through the first fastener, and then passes between the pair of first through holes from one side of the first crossbar again, and is placed at the end of the first through-hole. After passing through the first fastener again, it is fixedly connected to the first connecting belt 3, and forms a first loop (not shown in the figure) that sets one end of the first connecting belt 3 on the first crossbar. ), and finally fix the first connecting band 3 on the third extension part 21, the length of the first connecting band 3 between the first fastener and the connection between the first connecting band 3 and the third extending part 21 can be The movement adjustment is performed corresponding to the length of the first movement segment. As a preferred embodiment, the third extension portion 21 is provided with a limit ring through which the first movable segment passes.

In this embodiment, it also includes: a second interlayer disposed at the bottom rear end of the flexible chest pads 2, the second interlayer is respectively provided with a pair of second openings on both sides of the bottom rear end of the pair of flexible chest pads 2, the first Both ends of the two connecting straps 4 are respectively protruded from a pair of second openings, and the second connecting straps 4 are fixedly connected to the flexible chest pad 2 at the point where the second connecting straps 4 pass-through the second openings; the second fastener 6 includes a hollow first Two fastener frames 61, a second crossbar 611 disposed on the second fastener frame 61, the second crossbar 611 divides the hollow part of the second fastener frame 61 into a pair of second through holes 612; the third fastener 7. Including a hollow third fastener frame 71, a third cross bar 711 arranged on the third fastener frame 71, the third cross bar 711 divides the hollow part of the third fastener frame 71 into a pair of third through holes 712, the buckle structure 72 provided on the third buckle frame 71; one end of the second connecting band 4 is inserted from one side of the second cross bar 611 between a pair of second through holes 612, and the second The fastener 6 is worn on the second connecting belt 4, and the second connecting belt 4 forms a second movable section with adjustable length between the second fastener 6 and the flexible chest pad 2; After one end is passed through the second fastener 6, one end of the second connecting belt 4 is inserted between the pair of third through holes 712 from one side of the third cross bar 711, and the third fastener 7 is inserted through On the second connecting belt 4; after one end of the second connecting belt 4 passes through the third fastener 7, it passes through one side of the second cross bar 611 and between the pair of second through holes 612, and finally Pass out the second fastener 6.

In this embodiment, it further includes: a third connecting band 8, a third interlayer 15 disposed at the top rear end of the flexible back gasket 1, and a pair of third openings corresponding to the pair of second extending portions 12 are respectively opened in the third interlayer 15. 151, the two ends of the third connecting strip 8 are respectively protruded from a pair of third openings 151, and the third connecting strip 8 is fixedly connected to the flexible back gasket 1 at the place where it passes through the third opening 151; and the buckle structure 72 A matching card slot structure, the card slot structure includes: a card slot insertion frame 81, one end of the card slot insertion frame 81 is provided with a fourth crossbar, and a fourth crossbar is formed between the fourth crossbar and the card slot insertion frame 81. Through holes 812; one end of the third connecting band 8 is inserted between a pair of fourth through holes 812 from one side of the fourth crossbar, and the card slot inserting frame 81 is inserted on the third connecting band 8; One end of the third connecting band 8 is fixedly connected to the third connecting band 8 after passing through the card slot inserting frame 81, and forms a second loop for covering one end of the third connecting band 8 on the fourth crossbar 82.

The above are only preferred embodiments and are not intended to limit the embodiments. Any modifications, equivalent replacements, and improvements made within the spirit and principles of the embodiments shall be included within the scope of protection.

What is claimed:

1. An integrated pet harness with a pet leash, comprising:
a flexible back pad and a flexible chest pad, a pair of first connecting straps and a second connecting strap, which are arranged oppositely; and
a telescopic traction rope that is connected to the flexible back pad;
wherein the telescopic traction rope can be accommodated in the flexible back pad;
the front end of the flexible back pad is provided with a pair of first extension portions extending to both sides respectively, and the rear end of the flexible back pad is provided with a pair of second extension portions extending to both sides respectively;
the front end of the flexible chest pad is provided with a pair of third extension portions extending to both sides respectively;
a pair of the first connecting strips are respectively fixed to the front ends of the flexible back pads, and two ends of the pair of the first connecting strips are correspondingly protruded from the pair of the first extending parts and are respectively connected to a pair of third extensions; and
the second connecting strip passes through the rear end of the flexible back pad, and two ends of the second connecting strip are respectively connected to a pair of second extending portions.

2. The integrated pet harness with pet leash of claim 1, wherein the telescopic traction rope comprises:
an elastically retractable traction section and a hand-held section, wherein one end of the traction section is fixedly connected to the rear end of the flexible back pad, one end of the hand-held section is connected to the other end of the traction section, and the other end of the hand-held section is fixedly connected to the middle of the handle segment and forms a flexible handle for holding; and
the flexible back pad is provided with at least one first magnetic attraction structure, and one side of the traction section is provided with a second magnetic attraction structure matched with the first magnetic attraction structure.

3. The integrated pet harness with a pet leash of claim 2, wherein at least a third magnetic attraction structure is provided on the hand-held segment, and the third magnetic attraction structure is provided on the other side of the traction segment, wherein a fourth magnetic attraction structure is matched with the third magnetic attraction structure.

4. The integrated pet harness with a pet rope of claim 2, wherein the traction section is made of a retractable belt rope, and the inside of the flexible handle is provided with a non-slip lining.

5. The integrated pet harness with a pet rope of claim 1, further comprising:
a first interlayer that is arranged at the top front end of the flexible back gasket, wherein the first interlayer is respectively provided with a pair of first openings corresponding to a pair of the first extension parts, and
two ends of a pair of the first connecting strips correspondingly pass through a pair of the first openings, wherein the first connecting strip is fixed in the first interlayer, and the other end of the first connecting strip passes out of the first interlayer at the first opening, and the opening is fixedly connected to the flexible back gasket.

6. The integrated pet harness with a pet rope of claim 5, wherein:
the first fastener includes a hollow first fastener frame, and a first crossbar arranged on the first fastener frame, the first crossbar divides the hollow part of the first fastener frame into a pair the first through hole;
one end of the first connecting band is inserted between a pair of the first through holes from one side of the first crossbar, and the first fastener is inserted through the first connecting band above, the first connecting strip forms a first movable section with an adjustable length between the flexible back pad and the first fastener;
after one end of the first connecting band is passed out of the first fastener, it is again passed between a pair of the first through holes from one side of the first crossbar, and is passed through the first through-hole again;
After the first fastener is passed out, it is fixedly connected to the first connecting belt and forms a first loop for covering one end of the first connecting belt on the first crossbar;
the connecting strip is fixedly connected to the third extending part, and the length of the first connecting strip between the first fastener and the connection between the first connecting strip and the third extending part can correspond to the length of the first connecting strip; and describes the length activity adjustment of the first activity segment.

7. The integrated pet harness with a pet leash of claim 5, wherein:
the second interlayer is arranged at the bottom rear end of the flexible chest pad, the second interlayer is respectively provided with a pair of second openings on both sides of the bottom rear end of a pair of the flexible chest pads and the second connection, the two ends of the strap are respectively protruded from a pair of the second openings, and the second connecting strap is fixedly connected to the flexible chest pad at the place passing through the second openings.

8. The integrated pet harness with pet leash of claim 7, wherein:
the second fastener includes a hollow second fastener frame, and a second crossbar arranged on the second fastener frame, the second crossbar divides the hollow portion of the second fastener frame into a pair of second through holes;
the third fastener includes a hollow third fastener frame, and a third crossbar arranged on the third fastener frame, the third crossbar divides the hollow part of the third fastener frame into a pair of third through-holes, a buckle structure arranged on the third buckle frame;
one end of the second connecting band is inserted between the pair of second through holes from one side of the second crossbar, and the second fastener is inserted through the second connecting band on the upper part, the second connecting belt forms a second movable section with an adjustable length between the second fastener and the flexible chest pad;
after one end of the second connecting belt is passed through the second fastener, one end of the second connecting belt is passed through a pair of third through-holes from one side of the third crossbar between the pair of third through-holes, were the third fastener is on the second connecting belt; and
after one end of the second connecting belt is passed out of the third fastener, the second connecting belt is passed between one side of the second crossbar and the pair of second through-holes and passes out of the second through-hole.

9. The pet harness integrated with a pet rope of claim 8, further comprising
a card slot structure matched with the buckle structure, the card slot structure comprising:
a card slot insertion frame, wherein one end of the card slot insertion frame is provided with a fourth crossbar, a fourth through hole is formed between the fourth crossbar and the card slot insertion frame; wherein
one end of the third connecting strip passes through a pair of the fourth through holes from one side of the fourth crossbar, and the card slot is inserted into the frame through the set on the third connection belt; one end of the third connection belt is fixedly connected to the third connection belt after passing through the card slot insertion frame, and forms a middle part of the third connection belt, one end of the second collar is sleeved on the fourth crossbar, and
the third connecting strip is arranged on the third interlayer at the top and rear end of the flexible back pad, the third interlayer is respectively provided with a pair of third openings in the pair of second extension parts and the third connecting strip, the two ends of the pair of third openings respectively pass out of the third interlayer, and the third connecting strip is fixedly connected to the flexible back gasket at the place passing through the third openings.

10. The pet harness integrated with the pet leash of claim 5, wherein the third extension portion is provided with a limit ring through which the first movable segment passes.
